(19) United States
(12) Patent Application Publication
(10) Pub. No.: US 2026/0182607 A1
(43) Pub. Date: Jul. 2, 2026

(54) PREVENTION AND REVERSAL OF THE FORMATION OF UNDESIRABLE AROMAS AND FLAVORS IN BEVERAGES AND FOOD PRODUCTS

(71) Applicant: CERIA, INC., Arvada, CO (US)

(72) Inventors: Keith VILLA, Arvada, CO (US); Catherine Villa, Arvada, CO (US)

(21) Appl. No.: 19/131,624

(22) PCT Filed: Nov. 17, 2023
(86) PCT No.: PCT/US2023/080389

§ 371 Date: May 21, 2025

Related U.S. Application Data
(60) Provisional application No. 63/427,262, filed on Nov. 22, 2022.

(51) Int. Cl. A23L 2/56; A23F 3/16; A23F 3/40; A23G 3/36; A23G 3/48; C12C 5/02

(52) U.S. Cl. CPC A23L 2/56; A23F 3/166; A23F 3/405; A23G 3/362; A23G 3/48; C12C 5/026

(57) ABSTRACT

Methods to remove off-flavors and adverse aromas from hop-containing and/or cannabis-containing beverages and food products using Group 11 elements are described herein.

### FIELD OF THE INVENTION

The present disclosure is directed to various methods of controlling sulfurous compounds found in food products such as hop-containing edibles or beverages and/or cannabis-containing edibles or beverages. These methods can be used to prevent and/or remove undesirable, adverse flavors and/or aromas, sometimes described as ‘skunky’ or ‘sulfurous’, which are produced by exposing hop-containing edibles or beverages to visible and UV light and are also inherent to edible and drinkable products made with cannabis. These methods can also potentially be used to prevent and/or remove undesirable flavors and/or aromas in other foods or beverages containing sulfurous compounds not due to the presence of hops or cannabis.

### BACKGROUND OF THE INVENTION

It is commonly known that upon exposure to visible or UV light, strong off-flavors and aromas form in hop-containing beverages. These off-flavors, sometimes described as “skunky” or “sulfurous” are caused by the presence of 3-methyl-2-butene-1-thiol (MBT), a light sensitive, sulfurous compound that forms when hop-containing beverages are exposed to visible or UV light for as little as a few seconds. When exposed to light, MBT is produced by the decomposition of isomerized alpha acids (IAAs) contributed by hops. The human sensory threshold of detecting this off-flavor or aroma is 1-5 parts per trillion.

Hydrogen sulfide gas (H₂S), which may also contribute to the off-flavor and aroma of hop-containing beverages, is known to be formed as a byproduct of the fermentation process.

In beer, for example, brewers have attempted to prevent the formation of MBT in hop-containing beverages by packaging the finished product in dark brown bottles or cans to prevent visible light or UV exposure. Some brewers add modified hop products such as “light stable” bittering hops.

The MBT produced by cannabis plants has also been shown to contribute to the “skunky” adverse aroma of cannabis plants, as well as the adverse aroma and taste (off-flavor) of products derived from cannabis plants.

While MBT is one compound that contributes to the sulfurous off-flavors and aromas in both hop-containing beverages and cannabis containing edibles and beverages, other cannabis-derived compounds that may contribute to off-flavors and adverse aromas are 3-methyl-1-(methylthio)-2-butene, 3-methyl-2-butenyl acetothioate, bis(3-methyl-2-butenyl) sulfide, and bis(3-methyl-2-butenyl) disulfide.

The presence of MBT in cannabis will cause products made with cannabis to potentially also have the characteristic off-flavors and adverse aromas.

Presently disclosed are methods to prevent and/or remove the off-flavors and adverse aromas of food products and beverages associated with the presence of sulfurous compounds such as MBT, 3-methyl-1-(methylthio)-2-butene, 3-methyl-2-butenyl acetothioate, bis(3-methyl-2-butenyl) sulfide, and bis(3-methyl-2-butenyl) disulfide or H₂S.

### BRIEF DESCRIPTION OF THE DRAWINGS

FIG. 1 shows the formation of 3-methyl-2-butene-1-thiol from isomerized alpha acids after exposure to light in the presence of a photosensitizer. (Taken from De Keukeleire, Denis “Fundamentals of Beer and Hop Chemistry”, Quimica Nova. Vol. 23 (1) (2000) pp. 108-112).

FIG. 2 shows a Group 11 Cu²⁺ ion reacting, or binding, with a thiol group to neutralize the aroma associated with the thiol group.

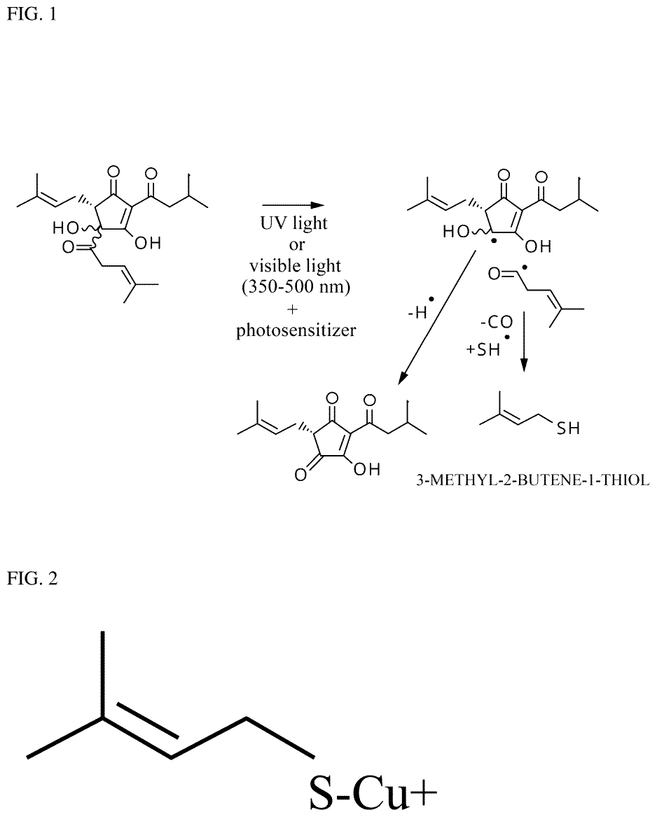

### SUMMARY OF THE INVENTION

Beers and other hop-containing beverages sometimes have sulfurous off-flavors and/or adverse aromas. At least one of the same sulfurous off-flavors and/or aromas are found in cannabis plants and food products (including beverages) derived from cannabis plants. Provided are methods to prevent and/or remove the off-flavors and adverse aromas found in beverage and food products by:
a. Adding a copper salt such as copper gluconate or other Group 11 elemental salts;
b. Exposing the beverage, food product or edible to piping or tubing, containing, made from or coated with copper or other Group 11 elements;
c. Filtering the beverage, food product or edible through a filtration matrix containing or made of copper or other Group 11 elements;
d. Adding pieces or particles of copper or other Group 11 elements to the beverage, food product or edible;
e. Exposing the beverage, food product or edible to an extract of yeast or other microorganisms enriched with copper or other Group 11 elements.
f. Exposing the beverage, food product or edible to light.

In one embodiment is a method for preventing or removing certain off-flavors and aromas in hop-containing beverages and food products by treatment with copper and/or copper salts, or purified forms and/or salts from other Group 11 elements, thereby preventing the sensory perception of sulfurous off-flavors or aromas. In one embodiment, Group 11 elements and/or salts thereof may be added at a concentration of 0.1 nM, to 1.0 M. In one embodiment, Group 11 elements and/or salts thereof may be added at a concentration selected from the group consisting of 0.1 nM, 1 nM, 1 μM, 1 mM and 1.0 M). Group 11 elements and/or salts thereof may be added before, during or after exposure to light, in order to prevent or reverse the sensory perception of sulfurous off-flavors or aromas.

In one embodiment is a method for preventing or removing certain off-flavors and aromas in beverages and food products derived from cannabis plants by treating with copper and/or copper salts, or purified forms and/or salts from other Group 11 elements, thereby preventing the sensory perception of sulfurous off-flavors or aromas. In one embodiment, Group 11 elements and/or salts thereof may be added at a concentration of 0.1 nM to 1.0 M. In one embodiment, Group 11 elements and/or salts thereof may be added at a concentration selected from the group consisting of 0.1 nM, 1 nM, 1 μM, 1 mM and 1.0 M. Group 11 elements and/or salts thereof may be added before, during or after the addition of cannabis or cannabis extracts to a beverage or food product.

In another embodiment, an antioxidant such as ascorbic acid, cinnamic acid derivatives, flavonoids, phenolic acids, polyphenols or other antioxidants may be added to a hop-containing beverage or food product, or cannabis containing beverage or food product, to prevent oxidation reactions from occurring thereby preventing or removing off-flavors or aromas. In one embodiment, antioxidants may be added at a concentration of 0.1 nM to 1.0 M. In one embodiment, antioxidants may be added at a concentration selected from the group consisting of 0.1 nM, 1 nM, 1 μM, 1 mM and 1.0 M. Antioxidants may be added before, during or after the addition of Group 11 elements and/or salts thereof to the beverage or food product.

In another embodiment, an antioxidant may be added to a hop-containing beverage or food product, or cannabis containing beverage or food product, that prevents heavy metal oxidation potentially caused by Group 11 elements and/or salts thereof. In one embodiment, antioxidants may be added at a concentration of 0.1 nM to 1.0 M. In one embodiment, antioxidants may be added at a concentration selected from the group consisting of 0.1 nM, 1 nM, 1 μM, 1 mM and 1.0 M. Antioxidants may be added before, during or after the addition of Group 11 elements and/or salts thereof.

In one embodiment is a method for preventing or removing certain off-flavors and/or aromas in a hop-containing or cannabis-containing beverage or food product, where the optimal amount of Group 11 elements and/or salts thereof is calculated based on the amount of potential off-flavors or adverse aromas present in the beverage or food product at the part per million (ppm), part per billion (ppb) or part per trillion (ppt) level.

In some embodiments the edible product is a food or beverage product.

In some embodiments the edible product is a breath spray, sublingual spray, pill, tablet, capsule, lozenge, paste, film or other dissolvable.

### Definitions

As used herein, the term “adverse aroma” refers to an unfavorable or undesirable aroma.

As used herein, the terms “odor” and “aroma” are used interchangeably and represent the sensory attributes of certain substances perceptibly determined by the olfactory system.

As used herein, the term “off-flavor” refers to an unfavorable or undesirable flavor that may be caused by components in food or beverage products.

As used herein, the term “food safe organic salt” refers to food grade salts that are suitable for their intended use and will not create a food safety hazard. This includes food safe salts of Group 11 metals.

As used herein, the terms “edible”, “food” and “food product” refer to foods and beverages and includes nutritional and sublingual sprays, pills, tablets, capsules, lozenges, pastes, films or other dissolvables.

As used herein, nutritional and sublingual sprays may be delivered via oral or nasal administration.

As used herein, the terms “gummy” or “gummies”, refer to a gelatin-based chewable food.

As used herein, the terms “hop-containing beverage” or “hop-containing edible” refer to any beverage or food product that contains hops, whether fermented or unfermented.

As used herein, the terms “cannabis containing beverage” or “cannabis containing edible” refer to any beverage or food product that contains cannabis, whether fermented or unfermented.

As used herein, the terms “extract of yeast or microorganisms” refers to a mixture of microorganisms that is in liquid or solid form.

As used herein, the term “cannabis extract” refers to a product that is formed through an extraction and separation process where cannabis plants are used as raw materials. The plants may be referred to as “hemp”, depending on the level of THC produced.

As used herein, the term “sensory threshold” refers to the ability of a human or other mammal to detect the presence of a sulfurous compound, off-flavor or adverse aroma by taste or smell.

As used herein, the Group 11 elements include and are not limited to copper (Cu), gold (Au) and silver (Ag).

As used herein, the abbreviation “MBT” refers to 3-methyl-2-butene-1-thiol.

As used herein, the abbreviation “THC” refers to tetrahydrocannabinol. The tetrahydrocannabinol can be produced synthetically or isolated from cannabis plants.

As used herein, THC may be derived from genetically modified organisms (GMOs).

As used herein, cannabis containing food or beverage products may contain cannabinoid compounds, THC, THC-like, or modified THC, that are produced synthetically, isolated from plants or isolated from genetically modified organisms.

As used herein, MBT and other sulfur containing compounds contributing to the off-flavor or adverse aromas of hop and/or cannabis containing food or beverage products may originate from plants. The MBT and other sulfur containing compounds may also be of synthetic or GMO origin.

### EMBODIMENTS

One embodiment describes a method for preventing or removing off-flavors and/or adverse aromas from hop-containing beverages and food-products by the addition of elemental and/or food grade salts of Group 11 metals, thereby preventing or eliminating the sensory perception of off-flavor sulfur compounds. Group 11 elements and/or salts thereof may be added at a concentration of 0.1 nM to 1.0 M. In one embodiment Group 11 elements and/or salts thereof may be added at a concentration selected from the group consisting of 0.1 nM, 1 nM, 1 μM, 1 mM and 1.0 M. In one embodiment, Group 11 elements are added before any exposure of the beverage or food product to light. In one embodiment Group 11 elements and/or salts thereof are added during exposure of the beverage or food product to light. In one embodiment Group 11 elements and/or salts thereof are added after exposure of the beverage or food product to light.

One embodiment describes a method for preventing or removing off-flavors and/or adverse aromas from cannabis-containing food and beverage products by the addition of elemental Group 11 metals such as copper, silver and gold, and/or food grade salts of Group 11 metals, thereby preventing or eliminating the sensory perception of off-flavor sulfur compounds. Group 11 elements and/or salts thereof may be added at a concentration of 0.1 nM to 1.0 M. In one embodiment Group 11 elements and/or salts thereof may be added at a concentration selected from the group consisting of 0.1 nM, 1 nM, 1 μM, 1 mM and 1.0 M. In one embodiment, Group 11 elements and/or salts thereof are added to the cannabis or cannabis extract, whether emulsified or not, before the cannabis or cannabis extract is added to food or beverage product. In another embodiment Group 11 elements and/or salts thereof are added to the food or beverage product after the addition of cannabis or cannabis extract to the food or beverage product.

In one embodiment a method is described to prevent heavy metal oxidation of hop-containing foods or beverages (while off-flavors and/or adverse aromas are removed) by adding an antioxidant to the food or beverage either before or after fermentation (if fermented). An antioxidant may be added at a concentration of 0.1 nM to 1.0 M. In one embodiment, an antioxidant may be added at a concentration selected from the group consisting of 0.1 nM, 1 nM, 1 μM, 1 mM and 1.0 M. In one embodiment an antioxidant is added to the hop-containing food or beverage product before the addition of Group 11 elements and/or salts thereof. In one embodiment an antioxidant is added to the hop-containing food or beverage product after the addition of Group 11 elements and/or salts thereof.

In one embodiment a method is described to prevent heavy metal oxidation of cannabis-containing foods or beverages (while off-flavors and/or adverse aromas are removed) by adding an antioxidant to the food or beverage. An antioxidant may be added at a concentration of 0.1 nM to 1.0 M. In one embodiment, an antioxidant may be added at a concentration selected from the group consisting of 0.1 nM, 1 nM, 1 μM, 1 mM and 1.0 M. In one embodiment an antioxidant is added to the food or beverage before the addition of the Group 11 elements and/or salts thereof. In one embodiment an antioxidant is added to the food or beverage after the addition of Group 11 elements and/or salts thereof.

In another embodiment a method is described wherein foods or beverages made with hop compounds are passed through a pipe, or a series of pipes or tubing, containing, made of, or coated with copper, silver, gold or other Group 11 elements to eliminate the sensory perception of adverse aromas and off-flavors. Exposure time in the pipe, series of pipes or tubing can range from 0.1 second(s) to 60 minutes (m) or more. In one embodiment exposure time in the pipe, series of pipes or tubing is selected from the group consisting of 0.1 s, 0.5 s, 1 s, 5 s, 10 s, 30 s, 60 s, 2 m, 3 m, 5 m, 10 m, 15 m, 30 m, 45 m, 60 m, 120 m and 180 m. In one embodiment the food or beverage is passed through the pipe or series of pipes or tubing before exposure to light. In one embodiment the food or beverage is passed through the pipe, or series of pipes or tubing, during exposure to light. In one embodiment the food or beverage is passed through the pipe, or series of pipes or tubing, after exposure to light.

In another embodiment a method is described wherein foods or beverages made with hop compounds are exposed to particles or “pieces” of copper, silver, gold or other Group 11 elements to eliminate the sensory perception of adverse-aromas and off-flavors. Exposure time to particles or “pieces” of copper, silver, gold or other Group 11 elements can range from 0.1 second(s) to 60 minutes (m) or more. In one embodiment exposure time to particles or “pieces” of copper, silver, gold or other Group 11 elements is selected from the group consisting of 0.1 s, 0.5 s, 1 s, 5 s, 10 s, 30 s, 60 s, 2 m, 3 m, 5 m, 10 m, 15 m, 30 m, 45 m, 60 m, 120 m and 180 m, at a concentration of approximately 0.1 nM to 1.0 M. In one embodiment the concentration of Group II elements is at a concentration selected from the group consisting of 0.1 nM, 1 nM, 1 μM, 1 mM and 1.0 M. In one embodiment the foods or beverages are exposed to particles or “pieces” of Group 11 elements before they are exposed to light. In one embodiment the foods or beverages are exposed to particles or “pieces” of Group 11 elements during exposure to light. In one embodiment the foods or beverages are exposed to particles or “pieces” of Group 11 elements after they are exposed to light.

In another embodiment a method is described wherein foods or beverages made with cannabis are passed through a pipe, or a series of pipes or tubing, containing, made of, or coated with copper, silver, gold or other Group 11 elements to eliminate the sensory perception of adverse aromas and off-flavors. Exposure time in the pipe, series of pipes or tubing can range from 0.1 second(s) up to 60 minutes (m) or more. In one embodiment, exposure time in the pipe series of pipes or tubing is selected from the group consisting of 0.1 s, 0.5 s, 1 s, 5 s, 10 s, 30 s, 60 s, 2 m, 3 m, 5 m, 10 m, 15 m, 30 m, 45 m, 60 m, 120 m and 180 m. In one embodiment the foods or beverages are passed through the pipe, or series of pipes or tubing, before the addition of cannabis. In one embodiment the foods or beverages are passed through the pipe, or series of pipes or tubing, after the addition of cannabis.

In another embodiment a method is described wherein foods or beverages made with cannabis are exposed to particles or “pieces” of copper, silver, gold or other Group 11 elements to eliminate the sensory perception of adverse aromas and off-flavors. Exposure time to particles or “pieces” of copper, silver, gold or other Group 11 elements can range from 0.1 second(s) to 60 minutes (m) or more. In one embodiment exposure time to particles or “pieces” of copper, silver, gold or other Group 11 elements is selected from the group consisting of 0.1 s, 0.5 s, 1 s, 5 s, 10 s, 30 s, 60 s, 2 m, 3 m, 5 m, 10 m, 15 m, 30 m, 45 m, 60 m, 120 m and 180 m at a concentration of approximately 0.1 nM to 1.0 M. In one embodiment the concentration of copper, silver, gold or other Group 11 elements is selected from the group consisting of 0.1 nM, 1 nM, 1 μM, 1 mM and 1.0 M. In one embodiment the foods or beverages are exposed to particles or “pieces” of Group 11 elements before the addition of cannabis. In one embodiment the foods or beverages are exposed to particles or “pieces” of Group 11 elements after the addition of cannabis.

In another embodiment a method is described wherein foods or beverages made with hop compounds are filtered through a filtration matrix which contains elemental copper, silver, gold or other Group 11 elements and/or salts thereof to eliminate the sensory perception of adverse aromas and off-flavors, so that the filtered product is free of such aromas and flavors. Group 11 elements and/or salts thereof may be present in the filtration matrix at a concentration of 0.1 nM to 1.0 M. In one embodiment Group 11 elements and/or salts thereof may be present at a concentration selected from the group consisting of 0.1 nM, 1 nM, 1 μM, 1 mM and 1.0 M. In one embodiment the foods or beverages are exposed to Group 11 elements and/or salts thereof before exposure to light. In one embodiment the foods or beverages are exposed to Group 11 elements and/or salts thereof during exposure to light. In one embodiment the foods or beverages are exposed to Group 11 elements and/or salts thereof after exposure to light.

In another embodiment a method is described wherein foods or beverages made with cannabis are filtered through a filtration matrix which contains elemental copper, silver, gold or other Group 11 elements and/or salts thereof to eliminate the sensory perception of adverse aromas and off-flavors, so that the filtered product is free of such aromas and flavors. Group 11 elements and/or salts thereof may be present in the filtration matrix at a concentration of 0.1 nM to 1.0 M. In one embodiment, Group 11 elements and/or salts thereof may be present in the filtration matrix at a concentration selected from the group consisting of 0.1 nM, 1 nM, 1 μM, 1 mM and 1.0 M. In one embodiment the foods or beverages are exposed to Group 11 elements and/or salts thereof before the addition of cannabis. In one embodiment the foods or beverages are exposed to Group 11 elements and/or salts thereof after the addition of cannabis.

In another embodiment a method is described wherein foods or beverages made with hop compounds are exposed to an extract of yeast or other microorganisms, wherein the microorganisms were exposed to Group 11 elements and/or salts thereof, wherein an extract of the microorganisms contains sufficient Group 11 elements and/or salts thereof to eliminate the sensory perception of adverse aromas and off-flavors. The extract of yeast or other microorganisms may be exposed to Group 11 elements and/or salts thereof at a concentration of 0.1 nM to 1.0 M. In one embodiment, the extract of yeast or other microorganisms may be exposed to Group 11 elements and/or salts thereof at a concentration selected from the group consisting of 0.1 nM, 1 nM, 1 μM, 1 mM and 1.0, for 1 second(s) to 24 hours (h) or more. In one embodiment, the extract of yeast or other microorganisms may be exposed to Group 11 elements and/or salts thereof for a time selected from the group consisting of 1 s, 30 s, 60 s, 5 m, 10 m, 15 m, 30 m, 45 m, 1 h, 3 h, 6 h, 12 h, 24 h and 48 h. In one embodiment, foods or beverages are exposed to an extract of yeast or other microorganisms for 1 second(s) to 24 hours (h) or more. In one embodiment, foods or beverages are exposed to an extract of yeast or other microorganisms for a time selected from the group consisting of 1 s, 30 s, 60 s, 5 m, 10 m, 15 m, 30 m, 45 m, 1 h, 3 h, 6 h, 12 h, 18 h, 24 h and 48 h. In one embodiment foods or beverages are exposed to yeast or other microorganisms that were previously exposed to Group 11 elements and/or salts thereof before exposing the foods or beverages to light. In one embodiment foods or beverages are exposed to yeast or other microorganisms that were previously exposed to Group 11 elements and/or salts thereof while exposing the foods or beverages to light. In one embodiment foods or beverages are exposed to yeast or other microorganisms that were previously exposed to Group 11 elements and/or salts thereof after exposing the foods or beverages to light.

In another embodiment a method is described wherein foods or beverages made with cannabis are exposed to an extract of yeast or other microorganisms, wherein the microorganisms were exposed to Group 11 elements and/or salts thereof, wherein an extract of the microorganisms contains sufficient Group 11 elements and/or salts thereof to eliminate the sensory perception of adverse aromas and off-flavors. The extract of yeast or other microorganisms may be exposed to Group 11 elements and/or salts thereof at a concentration of 0.1 nM to 1.0 M. The extract of yeast or other microorganisms may be exposed to Group 11 elements and/or salts thereof at a concentration selected from the group consisting of 0.1 nM, 1 nM, 1 μM, 1 mM and 1.0 M. The extract of yeast or other microorganisms may be exposed to Group 11 elements and/or salts thereof for 1 second(s) to 24 hours (h) or more. The extract of yeast or other microorganisms may be exposed to Group 11 elements and/or salts thereof for a time selected from the group consisting of 1 s, 30 s, 60 s, 5 m, 10 m, 15 m, 30 m, 45 m, 1 h, 3 h, 6 h, 12 h, 18 h, 24 h and 48 h.

In one embodiment, foods or beverages are exposed to an extract of yeast or other microorganisms for 1 second(s) to 24 hours (h) or more. In one embodiment, foods or beverages are exposed to an extract of yeast or other microorganisms for a time selected from the group consisting of 1 s, 30 s, 60 s, 5 m, 10 m, 15 m, 30 m, 45 m, 1 h, 3 h, 6 h, 12 h, 18 h, 24 h and 48 h. In one embodiment foods or beverages are exposed to yeast or other microorganisms that were previously exposed to Group 11 elements and/or salts thereof before the addition of cannabis. In one embodiment foods or beverages are exposed to yeast or other microorganisms that were previously exposed to Group 11 elements and/or salts thereof after the addition of cannabis.

In another embodiment, a method is described wherein the hop-containing food product is a nutritional or sublingual spray, pill, tablet, capsule, lozenge, paste, film or other dissolvable that contains elemental and/or food grade salts of Group 11 metals, thereby preventing or eliminating the sensory perception of adverse aromas and off-flavors contributed by sulfur compounds. Group 11 elements and/or salts thereof may be present in the food product at a concentration of 0.1 nM to 1.0 M. Group 11 elements and/or salts thereof may be present in the food product at a concentration selected from the group consisting of 0.1 nM, 1 nM, 1 μM, 1 mM and 1.0 M. In one embodiment Group 11 elements and/or salts thereof are added before any exposure of the food product to light. In one embodiment Group 11 elements are added during exposure to light. In one embodiment Group 11 elements and/or salts thereof are added after exposure to light.

In another embodiment a method is described wherein the cannabis-containing food product is a nutritional or sublingual spray, pill, tablet, capsule, lozenge, paste, film or other dissolvable that contains elemental and/or food grade salts of Group 11 metals, thereby preventing or eliminating the sensory perception of adverse aromas and off-flavors contributed by sulfur compounds. Group 11 elements and/or salts thereof may be present in the food product at a concentration of 0.1 nM to 1.0 M. Group 11 elements and/or salts thereof may be present in the food product at a concentration selected from the group consisting of 0.1 nM, 1 nM, 1 μM, 1 mM and 1.0 M. In one embodiment Group 11 elements and/or salts thereof are added to the cannabis-containing food product before the addition of cannabis or cannabis extract. In another embodiment Group 11 elements are added to the cannabis-containing food product after the addition of cannabis or cannabis extract.

One embodiment includes creating a mixture of hop or cannabis containing food product or beverage also containing Group 11 metal salts in an amount required to react with sulfurous compounds present in said food product or beverage. An antioxidant may be added, if needed, to said mixture to prevent or minimize heavy metal oxidation.

One embodiment includes a method for preventing or eliminating adverse aromas or off-flavors of a fermented or non-fermented hop or cannabis containing food product or beverage. The method also includes passing said food product or beverage through piping or tubing that contains or is made with Group 11 metal particles in an amount required to react with sulfurous compounds and adding an antioxidant, if needed, to said food product or beverage to prevent or minimize heavy metal oxidation.

One embodiment includes a method for preventing or eliminating adverse aromas or off-flavors of a fermented or non-fermented hop or cannabis containing food product or beverage where adverse aromas are undetectable at a human's sensory threshold.

One embodiment includes a method for preventing or eliminating adverse aromas or off-flavors of a fermented or non-fermented hop or cannabis containing food product or beverage where off-flavors are undetectable at a human's sensory threshold.

One embodiment includes a method for preventing or eliminating adverse aromas or off-flavors of a fermented or non-fermented hop or cannabis containing food product or beverage where adverse aromas are undetectable at a mammal's sensory threshold.

One embodiment includes a method for preventing or eliminating adverse aromas or off-flavors of a fermented or non-fermented hop or cannabis containing food product or beverage where off-flavors are undetectable at a mammal's sensory threshold.

One embodiment includes a method for preventing or eliminating adverse aromas or off-flavors of a fermented or non-fermented hop or cannabis containing food product or beverage. The method includes exposing said food product or beverage to Group 11 metal particles or a filtration matrix containing Group 11 metal particles in an amount required to react with sulfurous compounds and adding an antioxidant, if needed, to said food product or beverage to prevent or minimize heavy metal oxidation.

One embodiment includes a method for preventing or eliminating adverse aromas or off-flavors of a fermented or non-fermented hop or cannabis containing food product or beverage. The method includes exposing said food product or beverage to an extract of yeast or other microorganisms, where the yeast or other microorganisms were previously exposed to copper, silver, gold or other Group 11 elements, where said extract contains sufficient copper, silver, gold or other Group 11 elements to eliminate sulfurous aromas and flavors and adding an antioxidant, if needed, to said food product or beverage to prevent or minimize heavy metal oxidation.

### EXAMPLES

Example 1: To show the effect of the addition of copper (in the form of copper gluconate, CuGlu) on the production of adverse aromas in hop-containing beverages, four different beer types were sealed in clear glass bottles either with CuGlu or without. The samples were mixed gently then exposed to direct sunlight and finally evaluated for the presence of adverse aromas. The results are summarized in Table 1.

TABLE 1
Effect of copper on production of adverse aromas in beer
(samples were incubated in clear, colorless bottles).

| | Beverage type | 0.5M CuGlu | UV exposure | Adverse aroma |
|---|---|---|---|---|
| Sample | (300-400 mL) | (μL) | (104 klx) | present |
| 1 | Domestic Lager | 0 | 10 min | yes |
| 2 | Domestic Lager | 1000 | 10 min | NO |
| 3 | Domestic Lager | 0 | 10 min | yes |
| 4 | Domestic Lager | 20 | 10 min | NO |
| 5 | Domestic Lager | 0 | 15 min | yes |
| 6 | Domestic Lager | 16 | 15 min | minimal |
| 7 | Mexican Lager | 0 | 15 min | yes |
| 8 | Mexican Lager | 31 | 15 min | NO |
| 9 | Dutch Lager | 0 | 15 min | yes |
| 10 | Dutch Lager | 31 | 15 min | very minimal |
| 11 | Craft IPA | 0 | 15 min | yes |
| 12 | Craft IPA | 7 | 15 min | NO |

Example 2: To show the effects of the addition of copper (in the form of copper gluconate, CuGlu) on the production of adverse aromas and off-flavors in cannabis beverages, two different bottles of water infused with cannabis were sealed in clear glass bottles either with or without CuGlu. The samples were mixed gently then evaluated after 10 minutes at room temperature for the presence of adverse aromas. The results are summarized in Table 2.

TABLE 2
Effect of copper on the production of adverse aromas in water
(samples were incubated in clear, colorless bottles).

| | Beverage type | 0.5M | Adverse aroma |
|---|---|---|---|
| Sample | (300-400 mL) | CuGlu (μL) | present |
| 1 | Water infused with | 0 | yes |
| | cannabis | | |
| 2 | Water infused with | 50 | minimal |
| | cannabis | | |
| 3 | Water infused with | 100 | NO |
| | cannabis | | |
| 4 | Water infused with | 500 | NO |
| | cannabis | | |

Example 3: To show the effects of the addition of Group 11 salts (such as Ag, Au, silver proteinate, or gold thioglucose) on the production of adverse aromas or off-flavors in hop or cannabis containing beverage products, samples were exposed to Group 11 salts (in the form of silver proteinate). The samples were mixed gently then evaluated after 10 minutes at room temperature for the presence of adverse aromas. The results are summarized in Table 3.

TABLE 3
Effect of the addition of silver proteinate on the
production of adverse aromas or off-flavors in
hop or cannabis containing beverage products.

| | Beverage type | 0.5M Silver | Adverse |
|---|---|---|---|
| Sample | (200-1000 mL) | proteinate (uL) | aroma present |
| 1 | Non-alcoholic beer | 0 | Yes |
| | infused with cannabis | | |
| 2 | Non-alcoholic beer | 50 | minimal |
| | infused with cannabis | | |
| 3 | Non-alcoholic beer | 100 | NO |
| | infused with cannabis | | |
| 4 | Non-alcoholic beer | 500 | NO |
| | infused with cannabis | | |

Example 4: To show the effects of exposing hop or cannabis containing food or beverage products to pipes or tubing that are made of or that contain Group 11 metal particles, heated, liquified gummies are pumped through pipes or tubing that is surface-coated with copper particles, and then allowed to flow into molds to cool and harden. Sensory notes related to the presences of adverse aromas or off-flavors are given in Table 4.

TABLE 4
Effect of exposing heated, liquified cannabis-containing
gummies to copper prior to hardening.

| | | Exposure to copper | Adverse | Off- |
|---|---|---|---|---|
| | | particles in tubing | aroma | flavor |
| Sample | Food type | prior to cooling (min) | present | present |
| 1 | Cooled gummy | 0 | Yes | Yes |
| 2 | Cooled gummy | 0.5 | Yes | Yes |
| 3 | Cooled gummy | 1.0 | minimal | minimal |
| 4 | Cooled gummy | 5.0 | NO | NO |

Example 5: To show the effects of exposing hop or cannabis containing food or beverage products to Group 11 metal particles or a filtration matrix containing Group 11 metal particles: beer that contains hop material is filtered through a series of filters that are impregnated with silver particles, and the filtered beer is carbonated and packaged. A second beer that contains hop material was not filtered. Both beers are poured into glasses and then the glasses are exposed to bright, white light for 10 minutes and evaluated. The results are summarized in Table 5.

TABLE 5
Effect of filtering hop-containing beer through a filtration
matrix containing silver particles and then exposing to bright,
white light for 10 minutes. Sample 1 was not filtered.

| | | Gp 11 | Time of exposure to | Adverse | Off- |
|---|---|---|---|---|---|
| | | metal | bright, white light | aroma | flavor |
| Sample | Beer type | particle | (min) | present | present |
| 1 | Not Filtered | None | 10 | Yes | Yes |
| 2 | Filtered | Silver | 10 | NO | NO |

Example 6: To show the effects of exposing hop or cannabis containing food or beverage products to an extract of yeast or other microorganisms, wherein the yeast or other microorganisms were previously exposed to copper, silver, gold or other Group 11 elements, a tea made with cannabis is mixed with an extract of yeast in order to impart a unique yeast flavor. A second batch of tea with cannabis is mixed with a yeast extract that was exposed to a high amount of copper to impart unique yeast flavor plus copper particles. Both teas are exposed to bright, white light for 10 minutes and then evaluated. The results are summarized in Table 6.

TABLE 6
Effect of exposing cannabis containing tea to yeast extracts
enriched with copper or yeast extracts with no copper,
and exposing to bright, white light for 10 minutes.

| | | Copper | Adverse | Off- |
|---|---|---|---|---|
| | Beverage type | particle | aroma | flavor |
| Sample | (200-1000 mL) | concentration | present | present |
| 1 | Tea + yeast extract | 0 | Yes | Yes |
| 2 | Tea + copper enriched | 50 ppm Cu | Yes | Yes |
| | yeast extract | | | |
| 3 | Tea + copper enriched | 400 ppm Cu | minimal | minimal |
| | yeast extract | | | |
| 4 | Tea + copper enriched | 800 ppm Cu | NO | NO |
| | yeast extract | | | |

It will be apparent to those skilled in the art that various modifications and variations can be made in the methods and compositions of the present disclosure without departing from the spirit or scope of the disclosure.

1. A method for preventing or eliminating the sensory perception of adverse aromas or off-flavors of a food or beverage comprising:
a. creating a mixture of said food product or beverage also containing Group 11 metal salts in an amount required to react with sulfurous compounds present in said food product or beverage,
b. adding an antioxidant, if needed, to said mixture to prevent or minimize heavy metal oxidation; and
c. exposing said mixture to light.

2. The method of claim 1 wherein the elimination of adverse aromas or off-flavors are selected from the group consisting of adverse aromas or off-flavors present at less than 1 part per trillion, undetectable at a human's sensory threshold and combinations thereof.

3-5. (canceled)

6. A method for preventing or eliminating adverse aromas or off-flavors of a food product or beverage, comprising:
a. passing said food product or beverages through piping or tubing that contains or is made with Group 11 metal particles in an amount required to react with sulfurous compounds,
b. adding an antioxidant, if needed, to said food product or beverage to prevent or minimize heavy metal oxidation; and
c. exposing said mixture to light.

7. The method of claim 6 wherein the elimination of adverse aromas or off flavors are selected from the group consisting of adverse aromas or off-flavors present at less than 1 part per trillion, undetectable at a human's sensory threshold and combinations thereof.

8-10. (canceled)

11. A method for preventing or eliminating the sensory perception of adverse aromas or off-flavors of a food product or beverage, comprising:
a. exposing said food product or beverage to Group 11 metal particles or a filtration matrix containing Group 11 metal particles in an amount required to react with sulfurous compounds,
b. adding an antioxidant, if needed, to said food product or beverage to prevent or minimize heavy metal oxidation; and
c. exposing said mixture to light.

12. (canceled)

13. The method of claim 11 wherein the elimination of adverse aromas or off-flavors are selected from the group consisting of adverse aromas or off-flavors present at less than 1 part per trillion, undetectable at a human's sensory threshold and combinations thereof.

14-15. (canceled)

16. A method for preventing or eliminating the sensory perception of adverse aromas or off-flavors of a food product or beverage, comprising:
a. exposing said food product or beverage to an extract of yeast or other microorganisms, wherein the yeast or other microorganisms were previously exposed to copper, silver, gold or other Group 11 elements wherein said extract contains sufficient copper, silver, gold or other Group 11 elements to eliminate sulfurous aromas and flavors,
b. adding an antioxidant, if needed, to said food product or beverage to prevent or minimize heavy metal oxidation; and
c. exposing said mixture to light.

17. (canceled)

18. The method of claim 16 wherein the elimination of adverse aromas or off-flavors are selected from the group consisting of adverse aromas or off-flavors present at less than 1 part per trillion, undetectable at a human's sensory threshold and combinations thereof.

19-40. (canceled)

41. The method of claim 1 wherein the food product or beverage is selected from the group consisting of a fermented hop beverage, a non-fermented hop beverage, a hop containing food product, a fermented cannabis containing beverage, a non-fermented cannabis containing beverage and a cannabis containing food product.

42. The method of claim 1 wherein the adverse aromas or off flavors are due to the presence of a compound selected from the group consisting of MBT, 3-methyl-1-(methylthio)-2-butene, 3-methyl-2-butenyl acetothioate, bis(3-methyl-2-butenyl) sulfide, bis(3-methyl-2-butenyl) disulfide, H₂S and combinations thereof.

43. The method of claim 6 wherein the food product or beverage is selected from the group consisting of a fermented hop beverage, a non-fermented hop beverage, a hop containing food product, a fermented cannabis containing beverage, a non-fermented cannabis containing beverage and a cannabis containing food product.

44. The method of claim 6 wherein the adverse aromas or off flavors are due to the presence of a compound selected from the group consisting of MBT, 3-methyl-1-(methylthio)-2-butene, 3-methyl-2-butenyl acetothioate, bis(3-methyl-2-butenyl) sulfide, bis(3-methyl-2-butenyl) disulfide H₂S and combinations thereof.

45. The method of claim 11 wherein the food product or beverage is selected from the group consisting of a fermented hop beverage, a non-fermented hop beverage, a hop containing food product, a fermented cannabis containing beverage, a non-fermented cannabis containing beverage and a cannabis containing food product.

46. The method of claim 11 wherein the adverse aromas or off-flavors are due to the presence of a compound selected from the group consisting of MBT, 3-methyl-1-(methylthio)-2-butene, 3-methyl-2-butenyl acetothioate, bis(3-methyl-2-butenyl) sulfide, bis(3-methyl-2-butenyl) disulfide and H₂S and combinations thereof.

47. The method of claim 16 wherein the food product or beverage is selected from the group consisting of a fermented hop beverage, a non-fermented hop beverage, a hop containing food product, a fermented cannabis containing beverage, a non-fermented cannabis containing beverage and a cannabis containing food product.

48. The method of claim 16 wherein the adverse aromas or off-flavors are due to the presence of a compound selected from the group consisting of MBT, 3-methyl-1-(methylthio)-2-butene, 3-methyl-2-butenyl acetothioate, bis(3-methyl-2-butenyl) sulfide, bis(3-methyl-2-butenyl) disulfide and H₂S and combinations thereof.
